(19) United States
(12) Patent Application Publication
(10) Pub. No.: US 2010/0265070 A1
(43) Pub. Date: Oct. 21, 2010

(54) APPARATUS AND METHOD THAT PREVENT COLLISION OF TAGS IN RFID SYSTEM

(75) Inventors: Dong-Beom Shin, Daejeon (KR); Kwang-Soo Cho, Daejeon (KR); Heyung Sub Lee, Daejeon (KR); Cheol Sig Pyo, Daejeon (KR); KyungHi Chang, Seoul (KR); In-Chan Song, Incheon (KR); Fan Xiao, Incheon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/808,131

(22) PCT Filed: Dec. 8, 2008
(86) PCT No.: PCT/KR2008/007257

§ 371 Date: Jun. 29, 2010

(30) Foreign Application Priority Data
Dec. 13, 2007 (KR) 10-2007-0130156
Mar. 5, 2008 (KR) 10-2008-0020508

(51) Int. Cl. G08B 13/14

(52) U.S. Cl. 340/572.4

(57) ABSTRACT

Disclosed is an apparatus and method for preventing a collision in an RFID system, the method including: transmitting a Query to at least one tag, verifying whether an adjustment of a slot counter is required based on a response received from the tag, adjusting the slot counter when the verifying verifies that the adjustment of the slot counter is required, and transmitting the adjusted slot counter to the tag using a QueryAdjust regardless of whether a current frame is completed.

### TECHNICAL FIELD

The present invention relates to an apparatus and method for preventing collision of tags in an RFID system, and particularly, to an apparatus and method for adjusting a slot counter (Q) regardless of whether a frame is completed when a tag is identified in a reader of an RFID system, thereby increasing a tag identification rate.

This work was supported by the IT R&D program of MIC/IITA. [2005-S-106-03, Development of Sensor Tag and Sensor Node Technologies for RFID/USN]

### BACKGROUND ART

A Radio Frequency Identification (RFID) system identifies a tag that is attached to an object without contact through a signal, and thereby can process data. The RFID system includes a reader for reading and decoding, a tag including information about itself, operation software, and a network.

Currently, RFID systems in various frequency bands from a low frequency of under 150 kHz to a microwave frequency of over 5 GHz have been commercialized, and standardization thereof is managed by IEC JTC1/SC31/WG4 under International Standardization Organization (ISO). SG3, one of five sub-groups of WG4, manages standardization of an air interface for each RFID frequency band.

In the RFID system, a reader performs communication through wireless channel and identifies each tag. First, the reader transmits a signal, and tags in an identification area of the reader respond to the signal from the reader. When a plurality of tags exist in the identification area, since the tags simultaneously respond to the signal of the reader, a collision may occur, and thus the reader can not obtain accurate information.

A method for solving the collision problem is a kernel of the RFID and the method is called Anti-Collision-Algorithm.

An effective Anti-Collision-Algorithm that can identify a multi-tag in a mass RFID system environment where many products should be identified in real-time, such as a circulation and distribution field is absolutely required. The Anti-Collision-Algorithm is roughly classified into a tree-based clustering algorithm and a slotted ALOHA-based probability algorithm.

Recently, UHF band is known as a suitable band to the circulation and distribution field, and thus its standardization rapidly progresses compared to other bands in response to strong requirements of an RFID market. Both ISO/IEC 18000-6 A type established as an International standard in August 2004 and an EPCglobal UHF Gen 2 which is currently amended to be standardized as 18000-6 C type use slotted-ALOHA based Anti-Collision-Algorithm.

FIG. 1 is a flowchart illustrating a process for preventing a collision when a reader of an RFID system identifies a tag according to a conventional art. Referring to FIG. 1, a conventional reader may initialize a slot counter (Q) in operation 100 and transmits a Query including the Q to the tag in operation 102.

Subsequently, in the reader, each slot receives a response from tags and the tags are identified. First, in operation 104, the reader verifies whether a current slot is an idle slot that fails to receive a response from the tag, and when the current slot is an idle slot, a number of idle slots are counted in operation 106 and the reader proceeds to operation 114.

When, as a result of the verifying in operation 104, the current slot is not the idle slot, the reader verifies whether the current is a collision slot to which a plurality of tags respond, and when the current slot is the collision slot, the reader counter counts a number of collision slots in operation 110 and proceeds to operation 114.

However, if, as a result of verifying in operation 108, the current slot is not the collision slot, the reader performs an appropriate function in a normal slot in operation 112. The appropriate function in the normal slot includes transmitting an ACK signal to the tag to notify that a response is received, verifying whether an error occurs using a Cyclic Redundancy Check (CRC) when tag identification information including CRC information is received from the tag, storing the tag identification information when there is no error.

Subsequently, the reader checks every slot included in a frame and verifies whether the frame is completed in operation 114, and when the frame is not completed, the reader requests a response from a tag corresponding to a next slot using a QueryRep in operation 116, and returns to operation 104 and repeatedly performs operations from 104 to 114.

If, as a result of checking of every slot and verifying of the frame in 114, the frame is completed, the reader verifies whether every tag is identified without a collision slot in operation 118, and when every tag is identified, the tag identification is completed.

However, if, as a result of verifying in operation 118, there is any collision slot, the reader adjusts the Q in consideration of a number of idle slots and a number of collision slots in operation 120, and transmits a QueryAdjust including the adjusted Q to the tag in operation 122, and returns to operation 104 to performs a series of operations.

As described in FIG. 1, although many idle slots or collision slots are generated, the conventional reader adjusts the Q that is a variable of adjusting of a slot number after the frame is completed, in consideration of a number of the idle slots and collision slots and the conventional reader transmits the adjusted Q to the tag so as to reduce collisions.

Accordingly, when there are a plurality of identifiable tags, there is a problem that, although a collision occurs, the reader has to wait until a frame is completed. Therefore, when there are a plurality of idle slots and collision slots, a method and apparatus for adjusting the Q is required even when the frame is not completed.

### DISCLOSURE OF INVENTION

### Technical Problem

An aspect of the present invention provides an apparatus and method for preventing a collision of tags in an RFID system.

Another aspect of the present invention also provides an apparatus and method for preventing a collision of tags to effectively identify multiple tags in an RFID system.

Another aspect of the present invention also provides an apparatus and method for preventing a collision that can adjust a slot counter (Q) regardless of whether a frame is completed when a tag is identified in a reader of an RFID system, thereby increasing a tag identification rate.

### Technical Solution

According to an aspect of the present invention, there is provided a method for preventing collision of tags, including: transmitting a Query to at least one tag, verifying whether an adjustment of a slot counter is required based on a response received from the tag, adjusting the slot counter when the verifying verifies that the adjustment of the slot counter is required, and transmitting the adjusted slot counter to the tag using a QueryAdjust regardless of whether a current frame is completed.

According to another aspect of the present invention, there is provided an apparatus for preventing collision of tags, including: a transmitting unit to transmit a signal to perform Reader-to-Tag Communication, a receiving unit to receive a response from a tag, a collision preventing unit to verify whether an adjustment of a slot counter is required based on a response received from the tag and adjusting the slot counter, and a controller to control to transmit the adjusted slot counter to the tag using a QueryAdjust regardless of whether a current frame is completed.

### BRIEF DESCRIPTION OF THE DRAWINGS

FIG. 1 is a flowchart illustrating a process for preventing collision when a reader of an RFID system identifies a tag according to a conventional art;

FIG. 2 illustrates a configuration of an RFID system using a method for preventing collision according to an example embodiment;

FIG. 3 is a flowchart illustrating a process for preventing collision when a reader of an RFID system identifies a tag according to an example embodiment;

FIG. 4 is a graph comparing a conventional method for preventing collision with a method for preventing collision according to the present invention with respect to a tag identification time;

FIG. 5 is a graph comparing a conventional method for preventing collision with a method for preventing collision according to the present invention with respect to a tag identification throughput;

FIG. 6 is a graph comparing a conventional method for preventing collision with a method for preventing collision according to the present invention with respect to a collision ratio;

FIG. 7 is a graph comparing a tag identification time when a preset value is a fixed value with a tag identification time when the preset value is a variable value, the preset value being a reference when a method for preventing collision according to an example embodiment determines whether to adjust a slot counter; and

FIG. 8 is a graph comparing a total number of slots required for identification of a tag when a preset value is a fixed value with a total number of slots required for identification of a tag when the preset value is a variable value, the preset value being a reference when a method for preventing collision according to an example embodiment determines whether to adjust a slot counter.

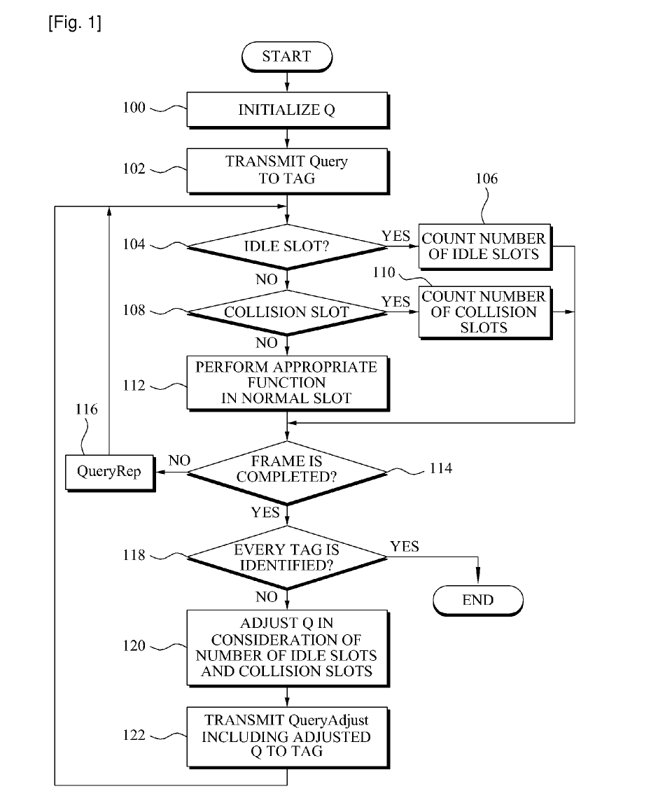

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

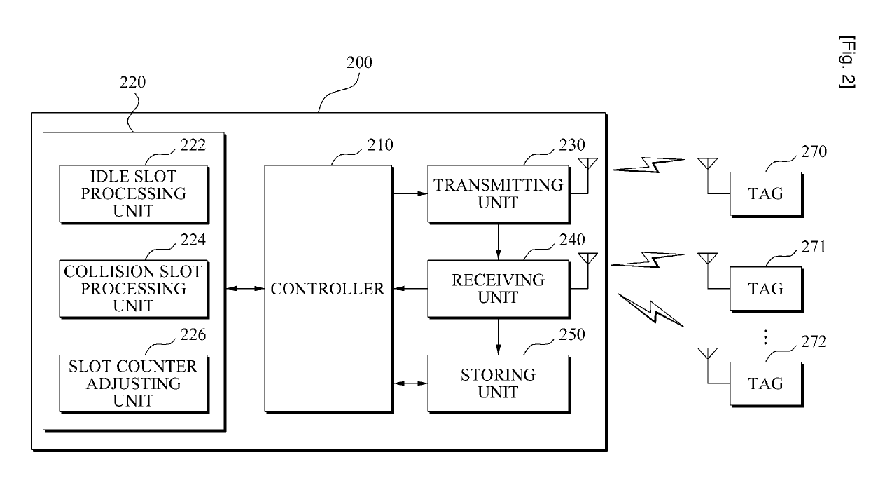

The present invention relates to a method for preventing collision which can adjust a slot counter (Q) regardless of whether a frame is completed when a tag is identified in a reader of an RFID system, and thereby can increase a tag identification rate. An apparatus thereof is described referring to FIG. 2 below.

FIG. 2 illustrates a configuration of an RFID system using a method for preventing collision according to an example embodiment. Referring to FIG. 2, the RFID system of the present invention is generally comprised of a reader 200 and tags 270, 271, and 272.

Next, the reader 200 includes a controller 220, a collision preventing unit 220, a transmitting unit 230, a receiving unit 240, and storing unit 250.

The transmitting unit 230 transmits commands such as a Query, QueryRep, QueryAdjust, and the like, to perform Reader-to-Tag Communication. The receiving unit 240 is in charge of receiving data from a tag. The storing unit 250 stores its own identification code (e.g. 64 bits of an electronic product code) of the tag, and provides the stored identification code to the controller 220 to identify the tag in response to a request of the controller 220.

The controller 220 controls the reader 200 that receives a command for operation of the reader 200 from an operator to identify the tag. Particularly, the controller 220 controls the transmitting unit 230 to transmit a Query including a Q to the tag and to transmit a QueryRep to the tag for a tag identification of a next slot. Also, a response received at each slot from the tag is controlled to be provided to a collision preventing unit 220, and also a QueryAdjust generated from the collision preventing unit 220 is controlled to be transmitted to the tag.

The control preventing unit 220 that adjusts a Q value based on frequency of occurrence of an idle slot and collision slot, includes a idle slot processing unit 222, collision slot processing unit 224, and slot counter adjusting unit 226.

Here, when the idle slot is successively generated a number of times equal to or greater than a preset value, the idle slot processing unit 222 decrements the Q regardless of whether a frame including every slot for the tag identification is completed and generates a QueryAdjust including the decremented Q to provide to the controller 210.

When the collision slot is successively generated a number of times equal to or greater than a preset value, the collision slot processing unit 224 increments the Q regardless of whether the frame is completed and generates a QueryAdjust including the incremented Q to provide to the controller 210.

When the tag identification is not completed after the frame is completed, the counter processing unit 226 may adjust the Q in consideration of a number of the idle slots and the collision slots, and generate a QueryAdjust including the adjusted Q to provide to the controller 210.

In this instance, the preset value being a reference value when determining a change of the Q, includes a fixed preset value that is a predetermined fixed value and a variable preset value that is changed in proportion to the slot counter value.

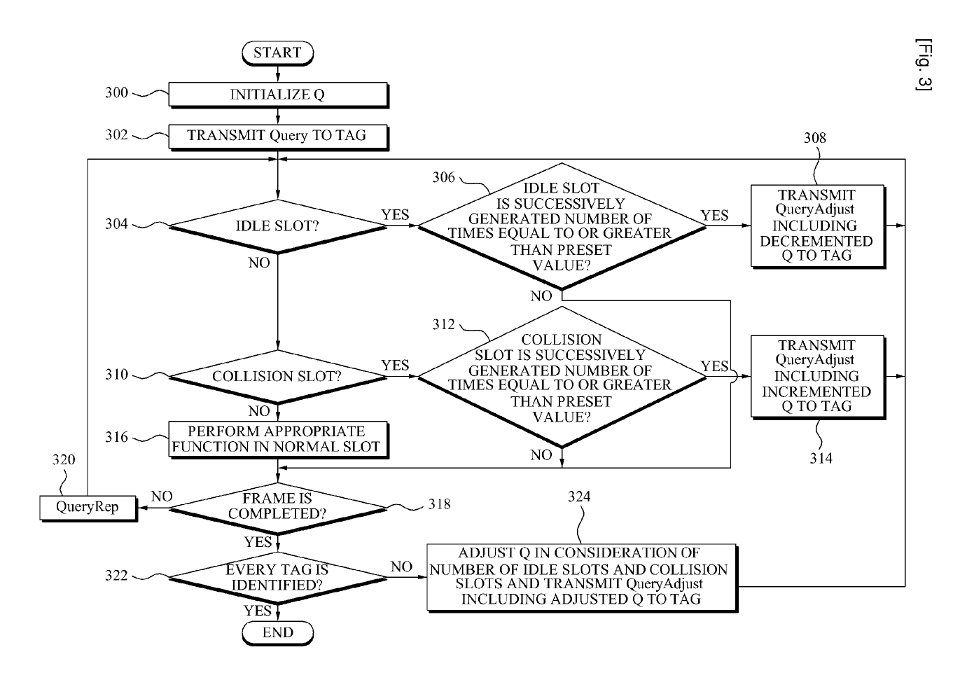

FIG. 3 is a flowchart illustrating a process for preventing a collision when a reader of an RFID system identifies a tag according to an example embodiment. Referring to FIG. 3, the reader of the present invention initializes a Q in operation 300 and transmits a Query including a slot counter to the tag in operation 302.

Subsequently, in the reader, each slot receives a response from tags and thereby, the tags are identified. First, in operation 304, the reader verifies whether a current slot is an idle slot that fails to receive a response from a tag, and when the current slot is an idle slot, the reader verifies whether the idle slot is successively generated a number of times equal to or greater than a preset value in operation 306. When the idle slot is not successively generated as a result of the verifying in operation 306, the reader proceeds to operation 318. Operation 318 will be described after describing operation 316.

However, when the idle slot is successively generated as a result of the verifying in operation 306, the reader decrements the Q and transmits a QueryAdjust including the decremented Q to the tag in operation 308, and then returns to operation 304.

When the current slot is not an idle slot as a result of verifying in operation 304, the reader verifies whether the current is a collision slot to which a plurality of tags respond, and when the current slot is verified to be the collision slot, the reader verifies whether the collision slot is successively generated a number of times equal to or greater than a preset value in operation 312. As a result of verifying in operation 312, when the collision slot is not successively generated, the reader proceeds to operation 318. Operation 318 will be described after describing operation 316.

However, when the collision slot is successively generated as a result of the verifying in operation 312, the reader increments the Q and transmits a QueryAdjust including the incremented Q to the tag in operation 314, and then returns to operation 304.

As a result of the verifying of operation 310, when the current slot is not the collision slot, the reader performs an appropriate function in a normal slot in operation 316. The appropriate function in the normal slot includes transmitting an ACK signal to the tag to notify that a response is received, verifying whether an error occurs using a Cyclic Redundancy Check (CRC) when tag identification information including CRC information is received from the tag, and storing the tag identification information when there is no error.

Subsequently, the reader checks every slot included in a frame and verifies whether the frame is completed in operation 318, and when the frame is not completed, the reader requests a response from a tag corresponding to a next slot using a QueryRep in operation 320, and returns to operation 304 and repeatedly performs operations from 304 to 318.

If the frame is completed as a result of checking of every slot and verifying of the frame in operation 318, the reader verifies whether every tag is identified without any collision slot in operation 322, and when every tag is identified, the tag identification is completed.

However, as a result of verifying in operation 322, if there is any collision slot, the reader adjusts the Q in consideration of a number of idle slots and a number of collision slots and transmits a QueryAdjust including the adjusted Q to the tag in operation 324.

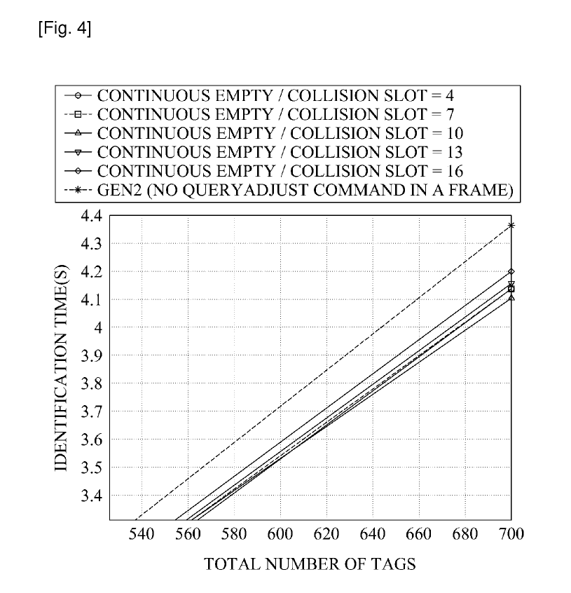

Hereinafter, the present invention and the conventional art are compared with respect to performance of a method for preventing collision referring to FIGS. 4 to 6.

FIG. 4 is a graph comparing a conventional method for preventing collision with a method for preventing a collision according to the present invention with respect to a tag identification time. The graph in FIG. 4 shows an amount of time required for tag identification with respect to a change of a number of tags in each method for preventing a collision. In the graph, Gen2 indicates the conventional method for preventing collision, and others respectively indicate a method for preventing a collision in each preset value. In this instance, the formulation, ‘Continuous Empty/Collision Slot=4’, indicates a method for preventing a collision when a preset value is 4, and also indicates that a Q may be changed, when an idle slot or collision slot is successively generated four times.

FIG. 4 confirms that the tag identification time of the present invention is shorter than that of the conventional art.

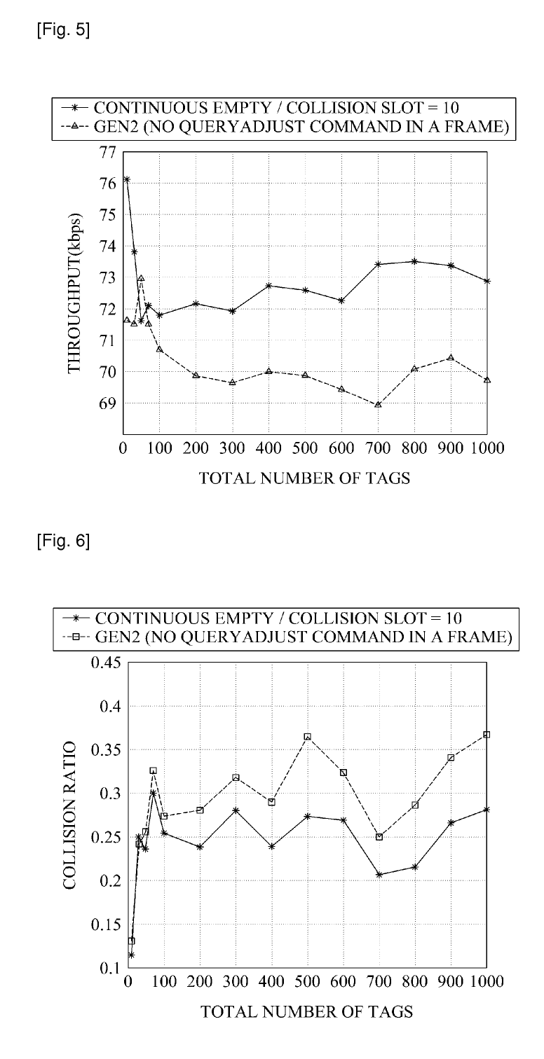

FIG. 5 is a graph comparing a conventional method for preventing collision with a method for preventing collision according to the present invention with respect to a tag identification throughput. The graph in FIG. 5 compares the conventional method for preventing a collision with the method for preventing a collision of the present invention with respect to a tag identification throughput with respect to a change of a number of tags. In the graph, Gen2 indicates the conventional method for preventing collision, and the formulation, ‘Continuous Empty/Collision Slot=10’, indicates a method for preventing collision of the present invention when a preset value is 10.

FIG. 5 confirms that the throughput of the method for preventing collision of the present invention is higher than that of the conventional art except when the number of the tags is about 50.

FIG. 6 is a graph comparing a conventional method for preventing collision with a method for preventing collision according to the present invention with respect to a collision ratio.

The graph in FIG. 6 compares the conventional method for preventing a collision with the method for preventing a collision of the present invention according to a collision ratio with respect to a change of a number of tags. In the graph, Gen2 indicates the conventional method for preventing collision, and the formulation, ‘Continuous Empty/Collision Slot=10’, indicates a method for preventing collision of the present invention when a preset value is 10.

FIG. 6 confirms that the collision ratio of the method for preventing collision of the present invention is lower than that of the conventional art except when the number of the tags is less than 50.

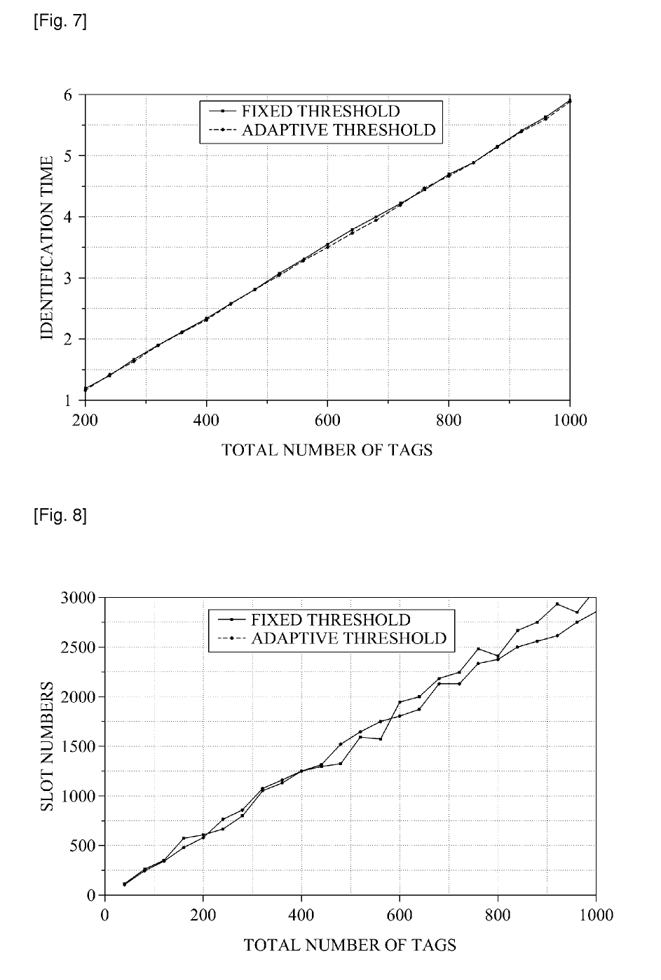

Next, a difference between when a preset value is a fixed value and when the preset value is a variable value is described below referring to FIGS. 7 to 8.

FIG. 7 is a graph comparing a tag identification time when a preset value is a fixed value with a tag identification time when the preset value is a variable value, the preset value being a reference when a method for preventing a collision according to an example embodiment determines whether to adjust a slot counter.

FIG. 8 is a graph comparing a total number of slots required for identification of a tag when a preset value is a fixed value with a total number of slots required for identification of a tag when the preset value is a variable value, the preset value being a reference when a method for preventing collision according to an example embodiment determine whether to adjust a slot counter.

Referring to FIGS. 7 and 8, although the performance when the preset value is fixed and the performance when the preset value is variable are similar, the performance when the preset value is fixed is higher than the performance when the preset value is variable is recognized.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for preventing collision of tags, comprising:
transmitting a Query to at least one tag;
verifying whether an adjustment of a slot counter is required based on a response received from the tag;
adjusting the slot counter when the verifying verifies that the adjustment of the slot counter is required; and
transmitting the adjusted slot counter to the tag using a QueryAdjust regardless of whether a current frame is completed.

2. The method of claim 1, wherein the verifying verifies whether the adjustment of the slot counter is required when an idle slot is successively generated a number of times equal to or greater than a preset value.

3. The method of claim 2, wherein, when the idle slot is successively generated, the preset value being a reference value of the verifying is a predetermined fixed value.

4. The method of claim 2, wherein, when the idle slot is successively generated, the preset value being is a reference value of the verifying is a variable value to be changed to a predetermined value determined according to the slot counter value.

5. The method of claim 2, wherein the adjusting comprises:
decrementing the slot counter when the idle slot is successively generated to be equal to or greater than the preset value.

6. The method of claim 1, wherein the verifying verifies whether the adjustment of the slot counter is required when a collision slot is successively generated a number of times equal to or greater than a preset value.

7. The method of claim 6, wherein, when the collision slot is successively generated, the preset value being a reference value of the verifying is a predetermined fixed value.

8. The method of claim 6, wherein, when the collision slot is successively generated, the preset value being a reference value of the verifying is a variable value to be changed to a predetermined value determined according to the slot counter value.

9. The method of claim 6, wherein adjusting further comprises:
incrementing the slot counter when the collision slot is successively generated equal to or more than the preset value.

10. An apparatus for preventing collision of tags, comprising:
a transmitting unit to transmit a signal to perform Reader-to-Tag Communication;
a receiving unit to receive a response from a tag;
a collision preventing unit to verify whether an adjustment of a slot counter is required based on a response received from the tag and adjusting the slot counter; and
a controller to control to transmit the adjusted slot counter to the tag using a QueryAdjust regardless of whether a current frame is completed.

11. The apparatus of claim 10, wherein the collision preventing unit comprises:
an idle slot processing unit to decrement the slot counter when the idle slot is successively generated a number of times equal to or greater than a preset value.

12. The apparatus of claim 10, wherein the collision preventing unit further comprises:
a collision slot processing unit to increment the slot counter when the collision slot is successively generated a number of times equal to or greater than a preset value.
